(19) United States
(12) Patent Application Publication
(10) Pub. No.: US 2010/0277324 A1
(43) Pub. Date: Nov. 4, 2010

(54) Diaper with Urine Sensor

(76) Inventor: Justin YEH, Taipei (TW)

Correspondence Address: Justin Yeh, 7F, No. 122 Sung Chiang Rd., Taipei, TW

(21) Appl. No.: 12/432,724

(22) Filed: Apr. 29, 2009

(51) Int. Cl. G08B 23/00

(52) U.S. Cl. 340/573.5

(57) ABSTRACT

A diaper with urine sensor, where at least a sensing line is laid on the surface of absorption layer of the diaper, and a bag is arranged nearby either end of the diaper and covered partially onto the sensing line, then a fixed urine sensor is arranged within the bag, so that the sensing point on the conduction surface gets contact with the sensing line for electrical connection; when the impedance of sensing line varies from the changing humidity of the absorption layer of the diaper, the signal will actuate the fixed urine sensor, e.g. sending an alarming sound, lamplight or vibration, thus notifying the users of replacing the diaper in a timely manner; the urine sensor can also be removed and recycled freely with extremely high cost-effectiveness and applicability.

### BACKGROUND OF INVENTION

1. Field of the Invention

The present invention relates generally to a diaper, and more particularly to an innovative one which is designed with a urine sensor.

2. Description of Related Art

The diapers have been evolved from re-washable cloth diapers to disposable paper diapers with the progress of science and technology; in particular, the disposable paper diapers of excellent water absorbability can absorb urine several times, but also make it difficult to detect the urine; so, a simple urine indicator strip has been developed in such a manner that it is arranged externally onto the diaper, whereby released urine can be reflected capillarity on the urine indicator strip. In such case, users can judge the occurrence of enuresis or otherwise without need of removing the diaper; such a design can help users detecting enuresis and duly replace the diaper, but also remove long-lasting contact with urine so as to reduce the probability of sickness.

However, there is still room for improvement of the diaper since inconvenience may occur in the case of failure of timely checking.

Thus, to overcome said problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The main objective of the present invention is to provide an innovative diaper with urine sensor, which features simple construction, higher accuracy and repeatability.

Another objective of the present invention is to provide a unique diaper with urine sensor, which can sense the users of diaper by wireless means, so as to realize more comprehensive range of operating efficacy.

At least a sensing line is laid on the surface of absorption layer of the conventional diaper, and a bag is arranged nearby either end of the diaper for assembly of a fixed urine sensor; the bag is partially covered onto the sensing line, so that the sensing point on the conduction surface of the fixed urine sensor gets contact with the sensing line for electrical connection; when the impedance of sensing line varies from the changing humidity of the absorption layer of the diaper, the signal will actuate the fixed urine sensor, e.g. sending an alarming sound, lamplight or vibration, thus notifying the users of replacing the diaper in a timely manner.

Said diaper mechanism comprises a displacement-type urine sensor, which can receive the signals sent by the fixed urine sensor, and then make a real-time response to notify the users of replacing the diaper.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows an outside perspective view of the preferred embodiment of the diaper of the present invention.

FIG. 2 shows an expanded plain view of the preferred embodiment of the diaper of the present invention.

FIG. 3 shows an expanded plain view of the other preferred embodiment of the diaper of the present invention.

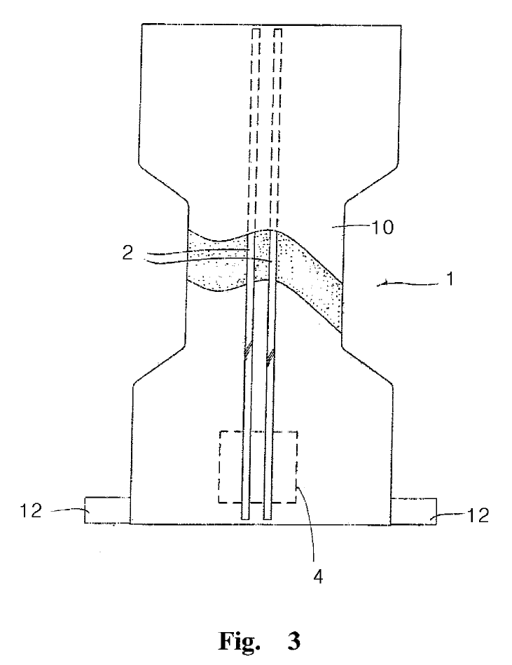

FIG. 4 shows a perspective view of the other preferred embodiment of the diaper of the present invention.

### DETAILED DESCRIPTION OF THE INVENTION

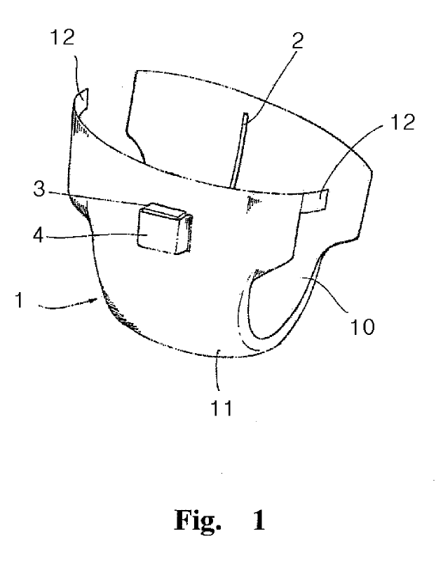

Referring to FIG. 1, an outside perspective view of the preferred embodiment of the diaper of the present invention, wherein the diaper 1 has a similar structure with typical diaper, which comprising: an internal absorption layer 10, an external water blocking layer 11 and two protruding snapping portions 12.

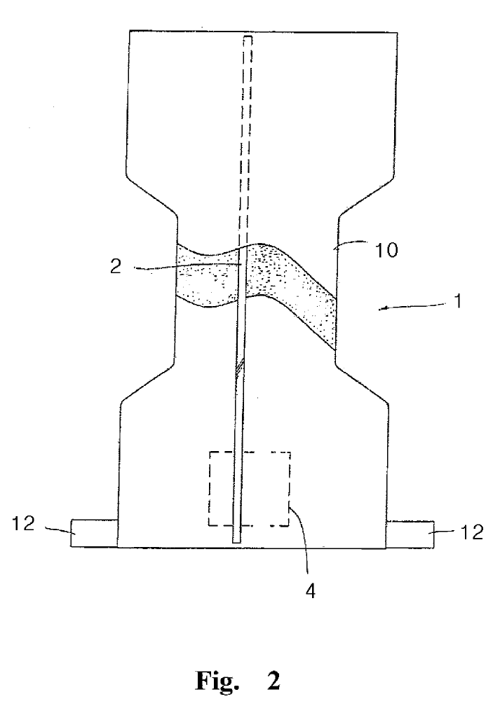

Referring to FIGS. 2˜3, at least a sensing line 2 is laid on the surface of absorption layer 10 of the diaper 1, and a bag 4 is arranged nearby either end of the diaper 1; moreover, the bag 4 is partially covered onto the sensing line 2, and a fixed urine sensor 3 is placed within the bag 4, so that the sensing point directly gets contact with the sensing line 2 for electrical connection in a simple way.

In practice, the sensing line 2 is laid on the surface of absorption layer 10 of the diaper 1 by means of printing, sewing and adhesion, etc; and the sensing line 2 is made of water-absorbent conductive material such as carbon ink. In other words, at least a sensing line 2 is adopted to prevent misjudgment for better sensing accuracy and effect.

When the impedance of sensing line 2 varies from the changing humidity of the absorption layer 10 of the diaper 1, the signal will actuate the fixed urine sensor 3, e.g. sending an alarming sound, lamplight or vibration, thus duly notifying the users of replacing the diaper 1 and eliminating the inconvenience.

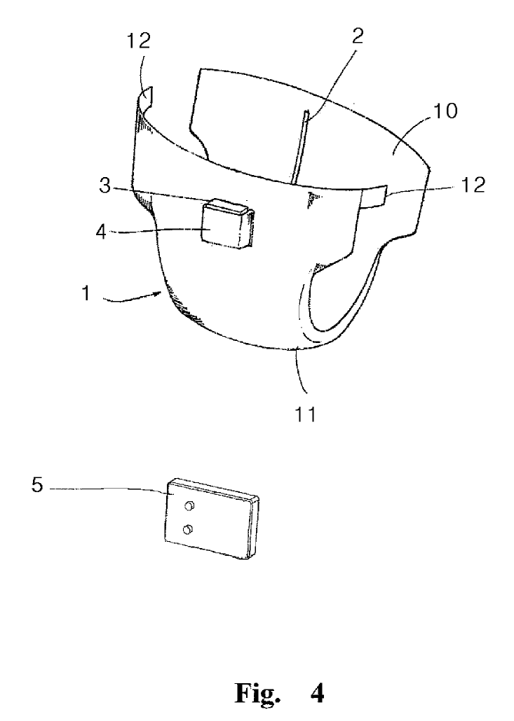

Referring to FIG. 4, a perspective view of the other preferred embodiment of the diaper of the present invention, wherein the diaper 1 structurally comprises the sensing line 2, bag 4 and fixed urine sensor 3, as well as a RF displacement-type urine sensor 5; of which the displacement-type urine sensor 5 can receive the signals sent by the fixed urine sensor 3, and then make a real-time response, e.g. sending an alarming sound, lamplight or vibration, thus notifying the users of replacing the diaper in a timely manner.

In practice, said RF urine sensor 5 can receive the signals from both a single user and multiple users, so as to realize more comprehensive range of operating efficacy; in addition, the fixed urine sensor 4 can be removed and recycled freely with extremely high cost-effectiveness and applicability.

In sum, the present invention has improved the existing diaper of unique structure, so the claims are filed hereby in accordance with the patent law.

Although the invention has been explained in relation to its preferred embodiment, it is to be understood that many other possible modifications and variations can be made without departing from the spirit and scope of the invention as hereinafter claimed.

1. A diaper with urine sensor comprising: an internal absorption layer, an external water blocking layer and two protruding snapping portions; it is characterized by that:
a sensing line is laid on the surface of absorption layer of the diaper, and a bag is arranged at either end of the diaper; the bag is partially covered onto the sensing line, and a fixed urine sensor is placed within the bag allowing the sensing point on the conduction surface to contact with the sensing line for electrical connection; when the impedance of sensing line varies from the changing humidity of the absorption layer of the diaper, the signal actuates the fixed urine sensor, thus providing notifying signal for the users to replace the diaper.

2. The diaper structure as claimed in claim 1, wherein at least one sensing line is laid on the surface of the absorption layer.

3. The diaper structure as claimed in claim 1, wherein the diaper comprises a displacement-type urine sensor, which receives the signals sent by the fixed urine sensor in the diaper, and then make a real-time response.
